(19) United States
(12) Patent Application Publication
(10) Pub. No.: US 2012/0212200 A1
(43) Pub. Date: Aug. 23, 2012

(54) Low Drop Out Voltage Regulator

(76) Inventors: Ahmed Amer, College Station, TX (US); Edgar Sánchez-Sinencio, College Station, TX (US)

(21) Appl. No.: 13/077,058

(22) Filed: Mar. 31, 2011

Related U.S. Application Data
(60) Provisional application No. 61/445,163, filed on Feb. 22, 2011.

(51) Int. Cl. G05F 1/10

(52) U.S. Cl. 323/282

(57) ABSTRACT

A low dropout voltage regulator (LDO) is presented that takes into consideration short channel effects of the pass transistor in suppressing ripples that are present at the input node of the LDO from appearing at the output node of the LDO. The LDO feeds the input ripple voltage to the gate of the pass transistor in such a way that the ripple currents through the pass transistor associated with both the transconductance and the output resistance of the pass transistor are suppressed. In one embodiment, the LDO is provided stability by using only on-chip capacitors. The size of on-chip capacitors is advantageously reduced by connecting a compensation capacitance to an internal node of an error amplifier. The LDO provides stable operation even at small load currents. The LDO also provides good suppression of ripples for a wide range of frequencies.

### CROSS REFERENCE TO RELATED APPLICATIONS

This application claims the benefit of U.S. Provisional Application No. 61/445,163, filed Feb. 22, 2011. This provisional application and its Exhibits are incorporated herein by reference in their entireties.

### FIELD OF THE INVENTION

The present invention relates to a low dropout voltage regulator that provides high input ripple suppression for wide range of load currents and wide range of frequencies.

### BACKGROUND

Integrated circuits, whether analog or digital, rely upon receiving a noise free power supply for optimum performance. However, integrated circuits can exist in environments that can inject considerable amount of noise onto the power supply. In such cases, an intermediary circuit becomes necessary to suppress the noise and provide a smooth power supply to the integrated circuits. For example, FIG. 1A shows a power management system in which power is supplied by a battery 101. Output of the battery 101 is fed to a switching power converter (SWPC) 102, which is a type of switching regulator. SWPC 102 is typically used for providing a voltage level that is different from the battery supply voltage V_{bat}. SWPC 102 employs high frequency switching circuitry to efficiently provide a regulated output voltage V_{sw}. However, as shown in waveform 106 of FIG. 1B, high frequency ripples due to switching tend to appear at output voltage V_{sw} 106 of the SWPC 102. To provide a ripple free supply voltage to the load 104, a low drop-out voltage regulator (LDO) 103 is employed to suppress the ripples produced by SWPC 102. As shown in FIG. 1B, the LDO 103 provides a smooth ripple free supply voltage V_{LDO} 107 to load 104 by cancelling the ripples appearing at its input voltage V_{sw} 106.

FIG. 1C shows a portion of an exemplary integrated circuit 91, which includes LDO 103 for supplying power to load 104. LDO 103 receives voltage V_{sw} from the SWPC 102 (not shown), which is located off-chip, via bonding pad 92a. LDO 103 suppresses ripples in V_{sw} to generate V_{LDO}, which is fed to circuit block 93. Circuit block 93 can be any analog and/or digital circuitry in need for ripple free supply voltage. Output of the LDO 103 is also connected to an off-chip load capacitor C_{L} 117 via a bonding pad 92b. Bonding pads 92a and 92b are connected to the I/O pins of the package in which the integrated circuit 91 is enclosed. As will be discussed later, the off-chip capacitor C_{L} 117 provides stability to the LDO 103. FIG. 1D is similar to FIG. 1C, except that the SWPC 102 is shown on-chip. In this case, the SWPC 102 receives V_{bat} from the battery 101 (not shown), located off-chip, via bonding pad 92a. SWPC 102 can also be connected to various passive devices, such as an inductor L and a capacitor C via additional bonding pads. Although only one LDO 103 is shown on integrated circuit 91 in FIGS. 1C and 1D, some system on chips (SoCs) may include more than one LDO, where each LDO supplies voltage to separate circuit blocks.

FIG. 2 shows a traditional LDO 103 with a p-channel pass transistor M_{P} 110 connected between the input Vᵢₙ and the output Vₒᵤₜ. LDO 103 strives to stop ripples present at Vᵢₙ 119 from appearing at Vₒᵤₜ 118. Resistor R_{L} 116 and capacitor C_{L} 117 represent the resistance and capacitance of the load 104 at the LDO 103 output. Resistors R_{f1} 114 and R_{f2} 115 form a voltage divider for sensing the output voltage Vₒᵤₜ and providing the sensed voltage to error amplifier 113. Error amplifier 113 compares the sensed voltage to a constant reference voltage V_{ref}. Any difference between the sensed voltage and the reference voltage V_{ref} is amplified and fed with opposite phase to the gate of pass transistor M_{P} 110 via n-channel transistor M₁ 111 and p-channel transistor M₂ 112. In other words, error amplifier 113 provides negative feedback to the gate of the pass transistor M_{P} 110 so that variations in output voltage Vₒᵤₜ are minimized.

Transistors M₁ 111 and M₂ 112 provide a voltage subtraction stage between the error amplifier 113 and the pass transistor M_{P} 110, which is so called because it subtracts the input voltage from the gate to source voltage of the pass transistor. The subtraction stage feeds ripples appearing in Vᵢₙ directly into the feedback loop and to the gate of the pass transistor M_{P} 110. Note that the current through the pass transistor M_{P} 110 is a function of its gate to source voltage (V_{gs}). Because the ripples appearing at Vᵢₙ (source of M_{P} 110) are also appearing at the gate of M_{P} 110, the variation in gate to source voltage due to the ripples at Vᵢₙ is very small. As a result, there is only a small change in current due to the ripples at Vᵢₙ.

Focusing on the small signal voltage v_{gp} appearing at the gate of pass transistor M_{P} 110 due to transistors M₁ 111 and M₂ 112, we can see that v_{gp} is found at a common node in a voltage divider formed of M₁ 111 and M₂ 112. This gate voltage v_{gp} can be expressed as:

$${v}_{gp} \approx \frac{{r}_{ds 1}}{1 / {g}_{m 2} + {r}_{ds 1}} \cdot {v}_{i n} \qquad ( 1 )$$

where r_{ds1} is output resistance of transistor M₁ 111 and gₘ₂ is the transconductance of transistor M₂ 112. A person skilled in the art will appreciate that 1/gₘ₂<<r_{ds1}. Therefore, Equation (1) reduces to:

$${v}_{gp} \approx \frac{{r}_{d s 1}}{{r}_{ds 1}} {v}_{i n} \approx {v}_{i n} \qquad ( 2 )$$

Thus, Equation (2) shows that the subtraction stage of LDO 103 feeds the variations appearing at the input voltage vᵢₙ directly to the gate of the pass transistor M_{P} 110.

The power supply rejection (PSR) offered by LDO 103 of FIG. 2 at DC and low frequencies can be expressed as the ratio of the output voltage vₒᵤₜ at node 118 to the input voltage vᵢₙ at the input node 119. The ratio vₒᵤₜ/vᵢₙ can be described as:

$$\frac{{v}_{out}}{{v}_{i n}} = \frac{{g}_{m p} ( 1 - \frac{{v}_{gp}}{{v}_{i n}} ) + {g}_{dsp}}{{A}_{ER} {A}_{2} {g}_{m p} β} \qquad ( 5 )$$

where, A_{ER} is the gain of the error amplifier 113, A₂ is the gain of the subtraction stage formed by M₁ 111 and M₂ 112, β is the equivalent resistance of the sense resistors R_{f1} 114 and R_{f2} 115 equal to R_{f2}/(R_{f1}+R_{f2}), and gₘₚ and g_{dsp} are the transconductance and output conductance of the pass transistor M_{P} 110.

As determined in Equation (2), v_{gp}≈vᵢₙ. Therefore, the first term in the numerator of Equation (5) will be zero, or very close to zero, and can be ignored. As a result, Equation (5) reduces to:

$$\frac{{v}_{out}}{{v}_{i n}} \approx \frac{{g}_{dsp}}{{A}_{ER} {A}_{2} {g}_{m p} β} \approx \frac{1}{{A}_{ER} {A}_{2} {g}_{m p} β {r}_{dsp}} \qquad ( 6 )$$

Equation (6) thus approximates the PSR offered by the LDO 103 of FIG. 2. Ideally, it is desirable that the ratio vₒᵤₜ/vᵢₙ equal zero. It is evident from Equation (6) that PSR is inversely proportional to the loop gain, which is the product of A_{ER}, A₂, gₘₚ, β, and r_{dsp}. Therefore, for the ratio of Equation (6) to be zero, or even approach zero, the loop gain needs to be very high, i.e., one or more variables of the denominator would have to be increased. For example, the gain A_{ER} of the error amplifier 113 can be increased. However, increasing the gain of the error amplifier 113 will be accompanied with increases in chip area and power consumption. Similar increases are associated with increasing the other variables of the denominator of Equation (6). Therefore, in traditional LDOs, achieving high PSR is accompanied with high costs in terms of power and chip area.

Stability is an important aspect of feedback circuits, such as the LDO 103 of FIG. 2. One way of providing stability is to connect a large capacitor at the output of the LDO, as shown by way of load capacitor C_{L} 117. Inclusion of C_{L} 117 causes the dominant pole of the open loop transfer function of LDO 103 to move to lower frequencies and farther away from higher frequency non-dominant poles. Thus, phase margin, and consequently, the stability of the feedback loop increases. However, the value of capacitor C_{L} 117 necessary to provide adequate phase margin is typically in the order of hundreds of nanofarads or higher. Such large capacitors require large areas, and are impractical to be included on a monolithic IC. Therefore, as previously shown in FIGS. 1C and 1D, C_{L} 117 is placed outside the integrated circuit 91, e.g., on the printed circuit board, and connected to the output of the LDO 103 via a dedicated I/O pin and bonding pad 92b. But, in SoCs that employ a large number of LDOs for various portions of the chip, an equally large number of I/O pins and bonding pads would be required to be dedicated to the sole purpose of connecting load capacitances to the LDOs.

Some prior art techniques avoid off-chip compensation capacitors by having an on-chip compensation capacitor Cₘ 108, as shown in FIG. 3. Capacitor Cₘ 108, also known as a Miller compensation capacitor, is added between the output of error amplifier 113 and the output terminal 118. The Miller capacitance Cₘ 108 at the output of the error amplifier 113 forms a dominant pole, while at the output node 118 it forms a non-dominant pole.

The higher the Miller capacitance Cₘ 108, the further the dominant pole is, in terms of frequency, from the non-dominant poles. Having the dominant pole farther from other non-dominant poles improves the phase margin, and therefore, stability of the LDO. Typically, a large Cₘ 108 (from 6 pF to 10 pF) has been employed in the prior art to provide adequate phase margin. But such large capacitors consume additional chip area, and are therefore undesirable. Furthermore, a large Cₘ 108 will degrade the transient response and PSR of the LDO at high frequencies.

Another drawback of the Miller compensation technique of FIG. 3 is that the LDO may become unstable at small load currents. This is because at small load currents, non-dominant poles at the output node 118 move closer to the dominant pole, which reduces phase margin and the stability of the feedback loop. Additionally, if the non-dominant poles are complex poles, peaking in magnitude response will occur, further de-stabilizing the feedback loop. Increasing the value of Cₘ 108 will address these problems, but as mentioned above is undesirable.

A solution to these problems is provided in this disclosure in the form of a new LDO circuit.

### BRIEF DESCRIPTION OF THE DRAWINGS

FIGS. 1A-1D illustrate a power management using an LDO in accordance with the prior art.

FIG. 2 illustrates an LDO with a subtraction circuit and off-chip load compensation in accordance with the prior art.

FIG. 3 illustrates an LDO with on-chip Miller compensation in accordance with the prior art.

FIG. 4 illustrates a schematic of a pass transistor of an LDO.

FIG. 5 illustrates a small signal model of the pass transistor of FIG. 4 showing the output current flowing through the transconductance and the output impedance of the pass transistor.

FIG. 6 illustrates the voltage fed to the gate of the pass transistor for providing suppression of ripples in accordance with an embodiment of the invention.

FIG. 7 illustrates a circuit diagram of an LDO implementing the suppression technique of FIG. 6 in accordance with an embodiment of the invention.

FIG. 8 compares power supply rejection curves of the LDO of FIG. 7 with that of the LDO of prior art.

FIG. 9 illustrates power supply rejection curves of the LDO of FIG. 7 for various load currents.

FIG. 10 illustrates an LDO using on-chip compensation for providing stability in accordance with an embodiment of the invention.

FIG. 11 illustrates a circuit diagram of the LDO of FIG. 10 in accordance with an embodiment of the invention.

FIG. 12 illustrates simulated magnitude and phase plots for various load currents of the LDO of FIG. 11.

FIGS. 13A and 13B show the measured transient load response of the LDO of FIG. 11.

FIGS. 14A and 14B show the measured transient line response of the LDO of FIG. 11.

FIG. 15 illustrates measured power supply rejection curves at various load currents of the LDO of FIG. 11.

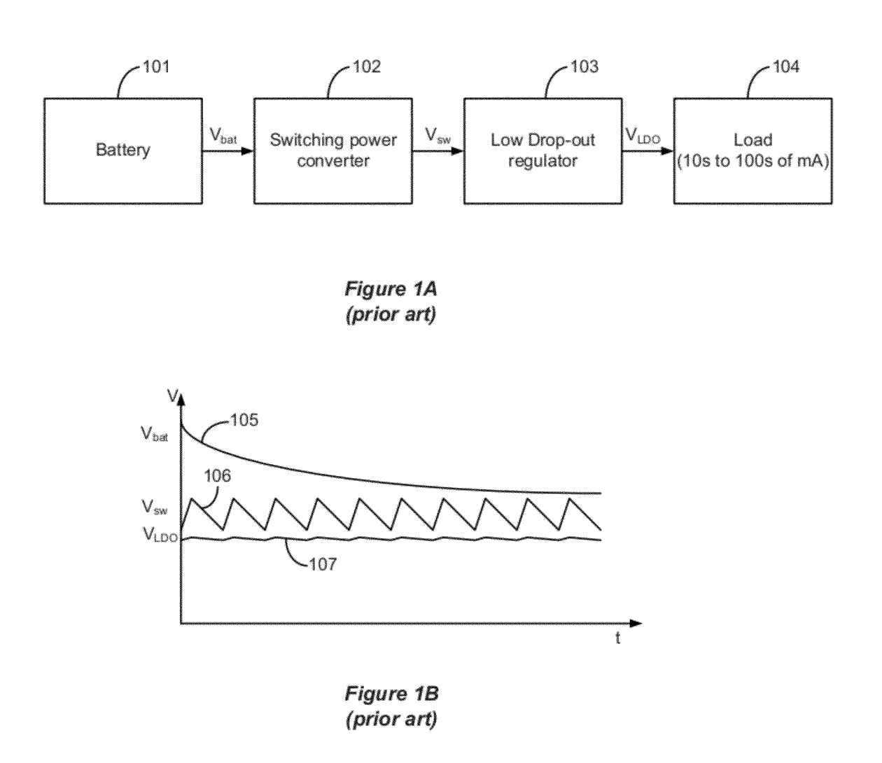

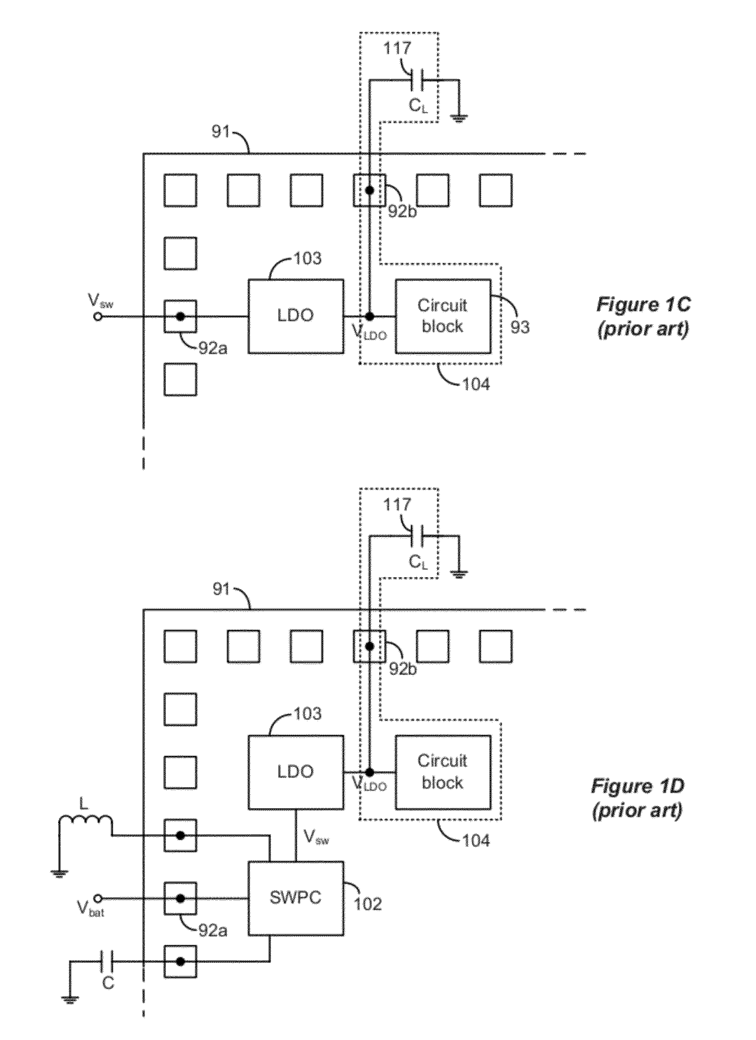

### DETAILED DESCRIPTION

The description that follows relates to use of the invention within a power supply management system. However, it is to be understood that the invention is not so limited, and could be used with any type of circuit where ripple suppression from one terminal to another is desired.

A low dropout voltage regulator (LDO) is presented that takes into consideration short channel effects of the pass transistor in suppressing ripples that are present at the input node of the LDO from appearing at the output node of the LDO. The LDO feeds the input ripple voltage to the gate of the pass transistor in such a way that the ripple currents through the pass transistor associated with both the transconductance and the output resistance of the pass transistor are suppressed. A sum of the input ripple voltage and the input ripple voltage multiplied by a gain equal to the reciprocal of the gain provided by the pass transistor is fed to the gate of the pass transistor. In one embodiment a transistor is utilized to provide the voltage multiplication. The transistor adapts to change in gain provided by the pass transistor due to changing load currents. In another embodiment, the LDO is provided stability by using only on-chip capacitors. The size of the on-chip capacitors is advantageously reduced by connecting a compensation capacitance to an internal node of an error amplifier. The LDO provides stable operation even at small load currents.

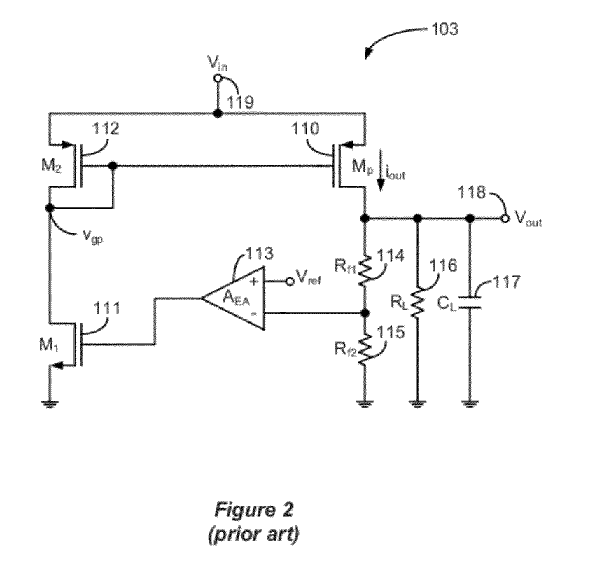

As discussed earlier, the prior art LDO 103 of FIG. 2, PSR can be increased only by increasing the open loop gain A_{ER}A₂gₘₚβr_{dsp}, and consequently, increasing the area and power consumption of the circuit.

The Inventors recognize that the prior art, and particularly the LDO 103 of FIG. 2, fails to take into account short channel effects of the pass transistor M_{P} 110. As a result, the subtraction stage of prior art LDO 103 addresses only the current path through the transconductance of the pass transistor M_{P} 110. In other words, it assumes that the small signal current iₒᵤₜ flowing through the pass transistor M_{P} 110 is equal to gₘₚv_{sg} only. Therefore by making v_{gp} equal to vᵢₙ, it assumes that the iₒᵤₜ will also be equal to zero. But it fails to address the current path through the output impedance of the pass transistor.

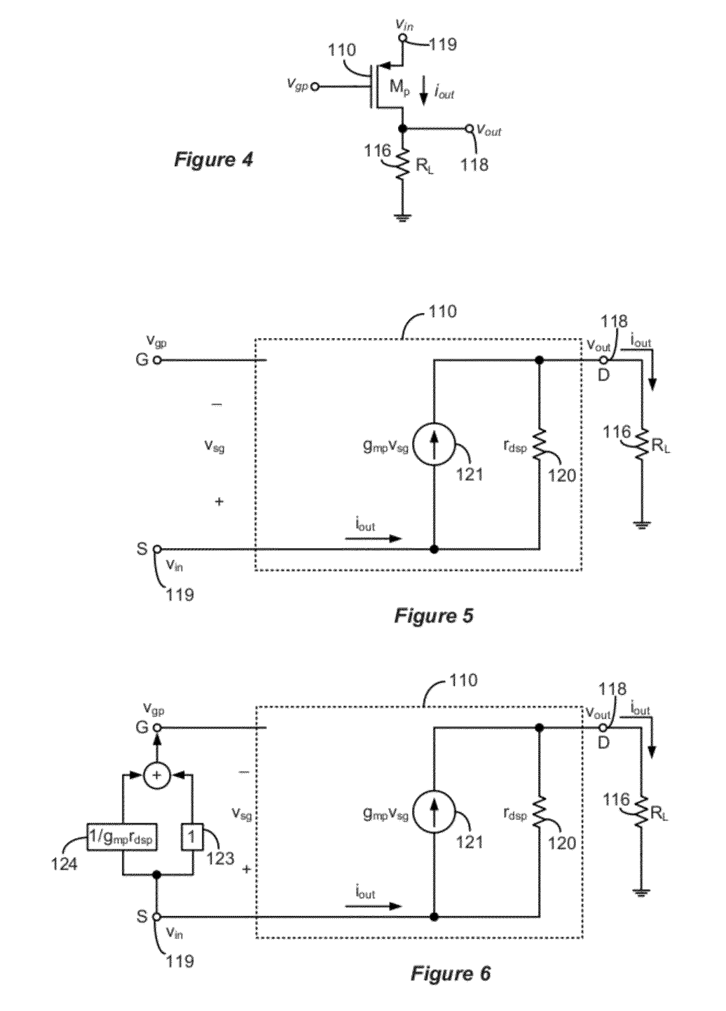

FIG. 4 shows the pass transistor M_{P} 110 connected to a load resistance R_{L} 116. FIG. 5 shows a short channel small signal model of the pass transistor M_{P} 110, where iₒᵤₜ is the output current of the LDO, gₘₚ and r_{dsp} are the transconductance and output resistance of the pass transistor M_{P} 110, v_{sg} is the source to gate voltage and v_{sd} is the source to drain voltage of pass transistor M_{P} 110. As evident from FIG. 5, current iₒᵤₜ flows through two paths in the transistor: the transconductance represented by the current source gₘₚv_{sg} and the output resistance represented by r_{dsp}. Therefore, the current iₒᵤₜ can be expressed as:

$${i}_{out} = {g}_{m p} {v}_{sg} + \frac{{v}_{sd}}{{r}_{dsp}} \qquad ( 7 )$$

Solving for vₒᵤₜ, we get:

$${v}_{out} = \frac{( {g}_{m p} + \frac{1}{{r}_{dsp}} ) {v}_{i n} - {g}_{m p} {v}_{gp}}{\frac{1}{{r}_{dsp}} + \frac{1}{{R}_{L}}} \qquad ( 8 )$$

Note that vₒᵤₜ represents the small signal variations or ripples that are present at the output node 119. Because one of the primary purposes of an LDO is to provide a ripple free vₒᵤₜ, we can determine the conditions for making vₒᵤₜ zero. Making the numerator of Equation (8) equal to zero is one such condition. By equating the numerator to zero, and solving for v_{gp} we get:

$${v}_{gp} = ( 1 + \frac{1}{{g}_{m p} {r}_{dsp}} ) {v}_{i n} = {v}_{i n} + \frac{{v}_{i n}}{{g}_{m p} {r}_{dsp}} \qquad ( 9 )$$

Thus, for vₒᵤₜ to be zero the gate of the pass transistor should be provided with the sum of vᵢₙ and vᵢₙ multiplied by 1/gₘₚr_{dsp}. FIG. 6 illustrates a schematic where vᵢₙ is fed to the gate voltage v_{gp} in accordance to Equation (9). Voltage vᵢₙ is multiplied by 1/gₘₚr_{dsp} in block 124, and multiplied by 1 in block 123. The outputs of blocks 123 and 124 are summed and the sum is fed to the gate of the pass transistor M_{P} 110. It should be noted that if block 124 were to be removed in FIG. 6, then the resultant circuit would represent the subtraction section (transistors M₁ 111 and M₂ 112) of the prior art LDO 103 of FIG. 2, in which the input voltage vᵢₙ was directly fed to the gate of the pass transistor M_{P} 110 such that the gate voltage v_{gp} was substantially equal to the input voltage vᵢₙ (see Equation (2) above). However, by including block 124, the circuit of FIG. 6 takes into account the current flowing through the output resistance r_{dsp} of the pass transistor M_{P} 110 to achieve a ripple free vₒᵤₜ. It should be also noted that gₘₚr_{dsp} represents the gain of the pass transistor M_{P} 110, which gain can be denoted as A_{MP}. Therefore, block 124 needs to offer a gain that is the reciprocal of the gain of the pass transistor to make vₒᵤₜ equal to zero. In other words, the product of the gain of the pass transistor and that of block 124 should be equal to 1.

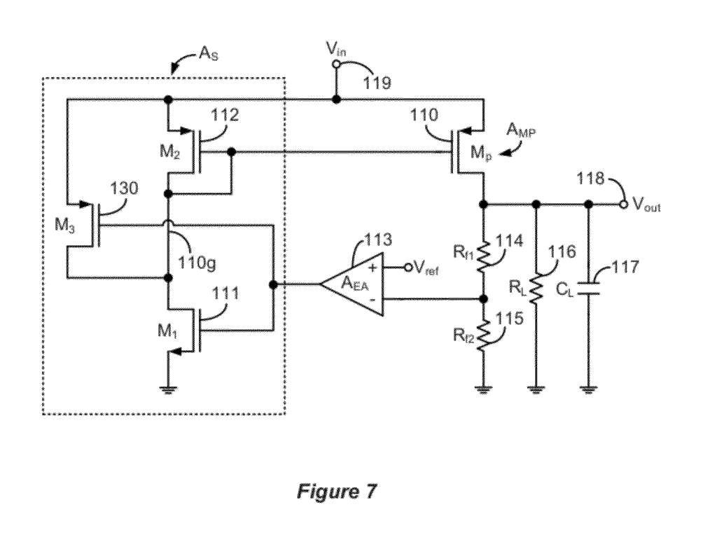

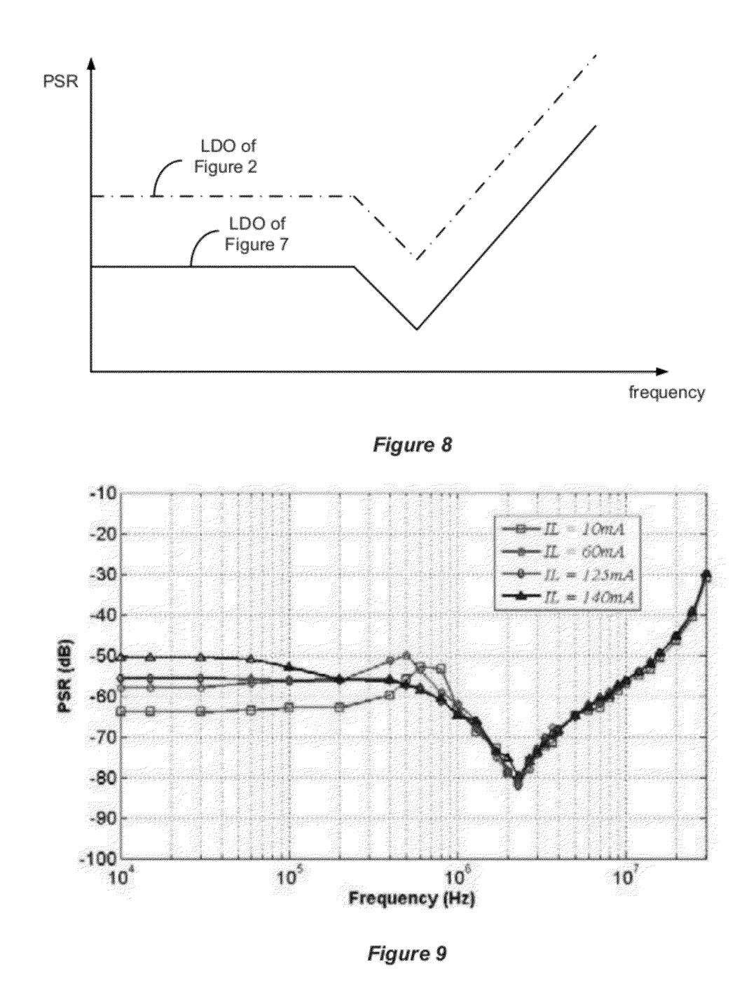

FIG. 7 shows one example of an LDO that cancels input ripple associated with both the transconductance and the output resistance of the pass transistor M_{P} 110. Although FIG. 7 shows an LDO circuit using only MOSFET transistors, it is understood that other types of transistors, such as bipolar junction transistor (BJTs) can also be used in place of one or more MOSFETs. New to the LDO of FIG. 7 is p-channel transistor M₃ 130 (compare to FIG. 2). Transistor M₃ 130 is connected between the input terminal 119 (Vᵢₙ), and v_{gp} and the gate of transistor M₃ 130 is connected to the output of the error amplifier 113. As shown in the analysis below, when the gain provided by transistors M₁ 111, M₂ 112, and M₃ 130 is equal to the reciprocal of the gain provided by the pass transistor M_{P} 110, the LDO of FIG. 7 can cancel out input ripples associated with both the transconductance and the output resistance of the pass transistor M_{P} 110. Further analysis of the LDO circuit of FIG. 7 is disclosed in “A 140 mA 90 nm CMOS Low Drop-out Regulator with −56 dB Power Supply Rejection at 10 MHz,” by Ahmed Amer and Edgar Sanchez-Sinencio, pp. 1-4, Custom Integrated Circuits Conference (CICC), IEEE, 19-22 Sep. 2010, which is incorporated herein by reference.

The small signals analysis of the LDO of FIG. 7 shows that the power supply rejection (PSR) at DC or low frequencies is given by the equation:

$$\frac{{v}_{out}}{{v}_{i n}} = \frac{1 - \frac{{g}_{m p} {r}_{dsp} {g}_{m 3}}{{g}_{m 2} + {g}_{ds 3}}}{( 1 + \frac{{r}_{dsp}}{{R}_{L}} ) ( 1 + {A}_{ol} )} \qquad ( 10 )$$

where, Aₒₗ is the open loop gain of the LDO, and is given by the equation:

$${A}_{ol} = \frac{{g}_{m 1} + {g}_{m 3}}{{g}_{m 2} + {g}_{ds 3}} \cdot \frac{{g}_{m p}}{\frac{1}{{R}_{L}} + {g}_{dsp}} \cdot β {A}_{EA} \qquad ( 11 )$$

In Equations (10) and (11), gₘ₁, gₘ₂, gₘ₃, and gₘₚ represent the transconductances of transistors M₁ 111, M₂ 112, M₃ 130, and M_{P} 110, respectively, while g_{ds1}, g_{ds3}, and g_{dsp} represent output conductances of transistors M₁ 111, M₃ 130, and M_{P} 110, respectively. β represents the feedback factor R_{f2}/(R_{f1}+R_{f2}) formed by sense resistors R_{f1} 114 and R_{f2} 115, A_{EA} represents the open loop gain of the error amplifier 113, and R_{L} 116 is the load resistance.

The ratio vₒᵤₜ/vᵢₙ in Equation (10) represents how much of the variations appearing at the input of the LDO will appear at the output. It is therefore desirable to make this ratio as close to zero as possible. Here too, we achieve this by making the numerator of Equation (10) equal to zero. In other words:

$$\frac{{g}_{m p} {r}_{dsp} {g}_{m 3}}{{g}_{m 2} + {g}_{ds 3}} = 1 \qquad ( 12 )$$

In Equation (12) the term gₘₚr_{dsp} is the gain A_{MP} of the pass transistor M_{P} 110. The remaining terms gₘ₃/(gₘ₂+g_{ds3}) can be considered as the gain A_{S} provided by the combination of transistors M₁ 111, M₂ 112, and M₃ 130. Therefore, another way to express Equation (12) is:

A_{MP}·A_{S}=1 (13)

Thus, as long as the product of gain of the pass transistor M_{P} 110 and gain A_{S} is equal to 1, the ratio vₒᵤₜ/vᵢₙ in Equation (10) will be equal to zero.

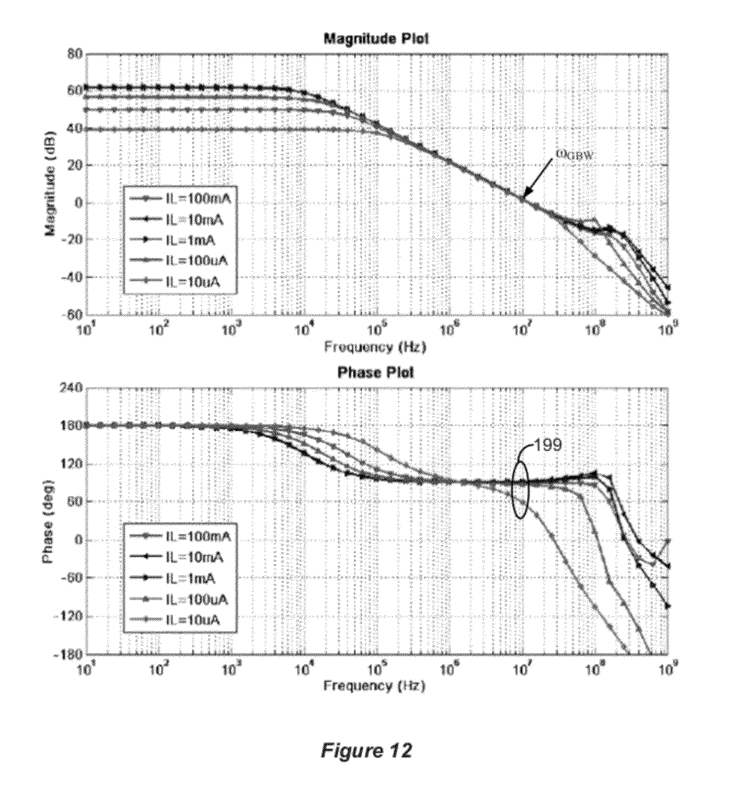

Practically, this desired mathematical relationship between the A_{MP} and A_{S} can be achieved by appropriate relative sizing (width and length) of transistors M_{P} 110, M₁ 111, M₂ 112, and M₃ 130. The size of the pass transistor M_{P} 110 is typically dictated by the design specification of the LDO. For example, the size of M_{P} 110 may be based on the magnitude of load current the LDO has to supply. Once the size of M_{P} 110 is known, its transconductance gₘₚ and output resistance r_{dsp} are also known. Subsequently, the sizes of transistors M₁ 111, M₂ 112, and M₃ 130 can be appropriately selected such that the resulting values of gₘ₃, gₘ₂, and g_{ds3} satisfy Equations (12) and (13). (Transistor M₁ 111 is not impacted by the variables in Equations 12 and 13, but is normally sized to match transistor M₂ 112). Although various sizes can be chosen, Table 1 below provides exemplary sizes for transistors M_{P} 110, M₁ 111, M₂ 112, and M₃ 130 for a particular implementation of the LDO of FIG. 7. While it may take some experimentation to determine the relative sizes of transistors 110, 111, 112, and 130 to arrive at the optimal conditions of FIG. 12, such experimentation would be routine for one skilled in the art.

While the prior art LDO of FIG. 2 required the open loop gain, and consequently chip area and power, to increase considerably to reduce the ratio vₒᵤₜ/vᵢₙ, the LDO of FIG. 7 accomplishes this by the appropriate addition of transistor M₃ 130 coupled with appropriate fabrication of the transistor 110, 111, 112, and 130 to arrive at the conditions of Equations (12) and (13) as just explained. Adding transistor M₃ 130 is far less costly in terms of chip area and power compared to similar costs associated with increasing, say, gain A_{EA} of the error amplifier 113.

FIG. 8 compares the theoretical frequency response of LDOs of FIG. 2 and FIG. 7. PSR is represented on the y-axis (in dB) and frequency is represented on the x-axis (log-scale). Because PSR is measured as the ratio of vₒᵤₜ/vᵢₙ, it is desirable to have as small a PSR value as possible, and in this respect, the LDO of FIG. 7 provides considerable improvement over the prior art LDO 103 of FIG. 2.

By using transistor M₃ 130, the product of A_{MP} and A_{S} remains close to the desired value of 1 even with changing load conditions. Note that the LDO may have to operate in conditions where the demand for current may vary considerably, which can result in large variations in the current flowing through the pass transistor M_{P} 110. Gain A_{MP} of pass transistor M_{P} 110 is a function of the current flowing through it. Specifically, A_{MP} varies inversely with the square root of the current (i.e., A_{MP}∝1/\sqrt{Iₒᵤₜ}). However, changes in load conditions also affect the gain of transistor M₃ 130 such that A_{S} varies directly with the square root of the load current (i.e., A_{S}∝\sqrt{Iₒᵤₜ}). Thus, changes in the gain of the pass transistor are compensated by an equivalent change in gain provided by transistor M₃, such that the product of A_{MP} and A_{S} remains close to 1. As a result, PSR remains substantially constant irrespective of the load. Exemplary approximate values of A_{MP} for smaller load currents is 10 while that for larger load currents is 3.

FIG. 9 shows PSR as a function of frequency for various values of load current ranging from 10 mA to 140 mA. Data shown in FIG. 9 was obtained from testing a test chip implementing the LDO of FIG. 7. At DC and lower frequencies, a load current magnitude change from 10 mA to 140 mA results in a change in PSR of only 15 dB. The worst case PSR at low frequencies is −50 dB. A PSR of −56 dB is achieved at 10 MHz.

Table 1 lists various metrics of the LDO tested in FIG. 9:

TABLE 1

| Parameter | value | |
|---|---|---|
| Technology | 0.09 | μm |
| Active Area | 0.015 | mm² |
| Input Voltage (Vᵢₙ) | 1.15 | V |
| Output Voltage (Vₒᵤₜ) | 1 | V |
| Dropout voltage | 0.15 | V |
| Maximum load current | 140 | mA |
| Quiescent load current | 33-145 | mA |
| Current Efficiency | 99.9% | |
| PSR @ 100 kHz | −53 | dB |
| PSR @ 1 MHz | −62 | dB |
| PSR @ 10 MHz | −56 | dB |
| Load Regulation | 0.043 | mV/mA |

| | |
|---|---|
| M₁ (width, length) | 1.3 μm, 0.16 μm |
| M₂ (width, length) | 2 μm, 0.16 μm |
| M₃ (width, length) | 0.7 μm, 0.16 μm |
| M_{P} (width, length) | 5000 μm, 0.08 μm |

Discussion now turns to improving stability to the LDO of FIG. 7 using only on-chip capacitances. The exemplary LDO of FIG. 7 was provided stability by using a large off-chip load capacitance C_{L} 117 of around 6 μF. This is not strictly required however; the load capacitance C_{L} 117 can be dispensed with in other useful implementations.

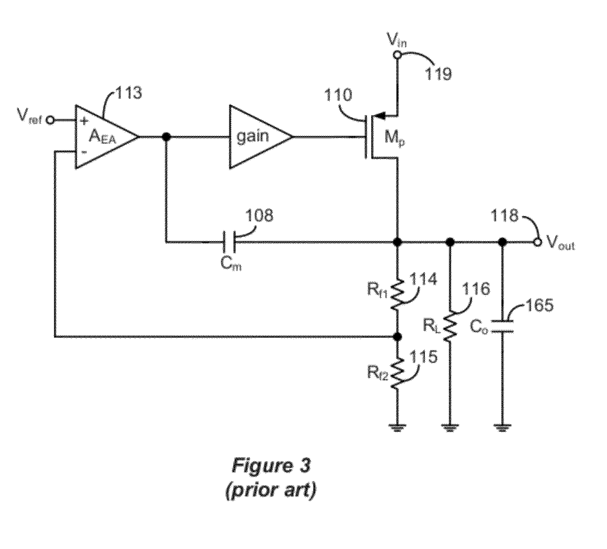

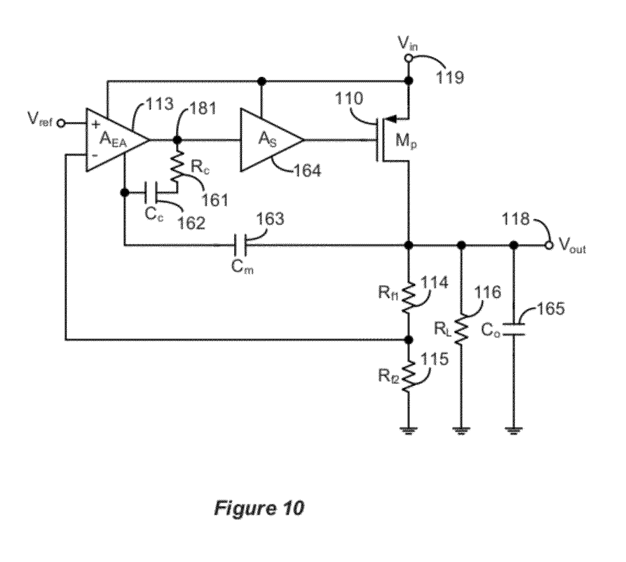

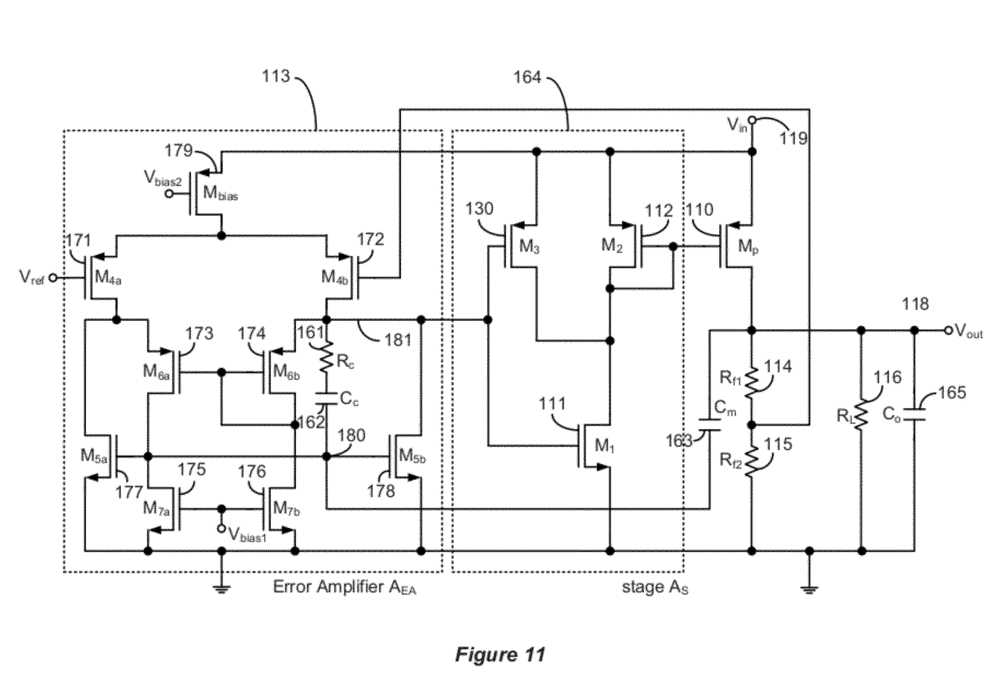

FIG. 10 shows an exemplary LDO that does not use an off-chip load capacitor for providing stability. Instead, a Miller compensation capacitor Cₘ 163 is used. However, unlike the prior art circuit of FIG. 3, in which Cₘ 108 is connected between the output of the error amplifier 113 and the output node 118 of the LDO, the LDO of FIG. 11 connects Cₘ 163 between an internal node of the error amplifier 113 and the output node 118 of the LDO. The internal node can be a node preceding a gain stage of the error amplifier. As discussed in detail below, by connecting one end of Cₘ 163 to the input of an internal gain stage of the error amplifier 113, the dominant pole is formed at that internal node. Also, the gain offered by that internal gain stage contributes to splitting the poles further apart. Thus, the capacitor Cₘ 163 can be small (e.g. smaller than Cₘ 108 in FIG. 3) for the same amount of pole-splitting. Note that because compensation is now provided by capacitor Cₘ 163, the load capacitor C_{L} 117 can be replaced by a relatively small capacitor Cₒ 165 (a few picofarads), which can be moved on-chip. A person skilled in the art will appreciate that by eliminating the need for off-chip capacitors, I/O terminals dedicated to such functionality are no longer necessary. Therefore, the chip containing the LDO can be made smaller and more simple.

Additionally, resistor R_{c} 161 and capacitor C_{c} 162 are connected in series between the internal node of the error amplifier 113 and the output of the error amplifier 113. R_{c} 161 is added to create a zero in the transfer function, which zero cancels the pole at the output node of the error amplifier 113. C_{c} 162 is added to place the dominant pole of the error amplifier at its internal node. The values of R_{c} 161 and C_{c} 162 are typically determined using computer simulation of the LDO of FIG. 11. Exemplary values of R_{c} 161 and C_{c} 162 for test chip implementing the LDO of FIG. 11 are listed in Table 2 below.

Output of the error amplifier 113 is connected to the input of amplifier A_{S} 164. A_{S} 164 can include transistors M₁ 111, M₂ 112, and M₃ 130 connected in the same configuration as shown in FIG. 7. However, this is not strictly necessary, and Aₛ can instead comprise any suitable amplification circuit.

FIG. 11 shows an exemplary circuit diagram of the LDO of FIG. 10 with the internal details of the amplifier circuits shown in more detail. The error amplifier 113 is followed by the stage A_{S} 164, the output of which is connected to the gate of the pass transistor M_{P} 110. A compensation capacitor Cₘ 163 is connected between the output node 118 and an internal node 180 of the error amplifier 113. Resistor R_{c} 161 and capacitor C_{c} 162 are connected in series between the internal node 180 and the output node 181 of the error amplifier 113.

Error amplifier 113 can be viewed as a two stage amplifier with stage 1 formed by transistors M₄ₐ, M_{4b}, M₆ₐ, M_{6b}, M₇ₐ, and M_{7b}, and stage 2 formed by transistors M₅ₐ and M_{5b}. Internal node 180 is located between stage 1 and stage 2. By connecting the compensation capacitor Cₘ 163 at the internal node 180, additional gain offered by stage 2 (M₅ₐ and M_{5b}) contributes to pole-splitting, which in turn increases phase margin and stability. Note that the error amplifier 113 can have a configuration different from the one shown in FIG. 11. For example, the error amplifier 113 may be any two stage amplifier with good power supply rejection ratio. The error amplifier 113 can also have more than two stages, in which case the output node of any of the internal stages can be used as the internal node 180.

The following discusses the reduction in frequency of the dominant pole, increase in frequency of the non dominant pole and reduction in magnitude peaking associated with non dominant poles, in the LDO of FIG. 11.

The gain provided by stage 1 of the error amplifier 113 can be expressed as:

$${G}_{m 1} {r}_{o 1} = \frac{{g}_{m 4} {r}_{o 2} {g}_{m 6} {r}_{o 1}}{1 + {g}_{m 6} {r}_{o 2}} \qquad ( 14 )$$

The gain provided by stage 2 of the error amplifier 113 can be expressed as:

Gₘ₂rₒ₂=gₘ₅rₒ₂ (15)

In Equations (14) and (15), gₘ₄, gₘ₅, and gₘ₆ represent the transconductances of transistors M₄ₐ and M_{4b}, M₅ₐ and M_{5b}, and M₆ₐ and M_{6b}, respectively; and rₒ₁ and rₒ₂ represent the output resistance at the outputs of stage 1 and stage 2 of the error amplifier 113. Additional variables introduced below are defined as follows: rₒ₃ represents the output impedance at the output of stage A_{S} 164 (at the gate of M_{P} 110); C_{gp} represents the total parasitic capacitance from the gate of the pass transistor M_{P} 110 to ground while C_{gdp} represents its gate to drain capacitance; gₘ₁, gₘ₂, gₘ₃, and gₘₚ represent the transconductances of transistors M₁ 111, M₂ 112, M₃ 130, and M_{P} 110 respectively; and R_{Leff}=R_{L}/r_{dsp} is the effective output resistance of the LDO neglecting the large sense resistors R_{f1} 114 and R_{f2} 115.

To simplify, Gₘ₃ and Gₘ₄ are defined as Gₘ₃=gₘ₁+gₘ₃ and Gₘ₄=gₘₚ.

The open loop transfer function for the LDO of FIG. 11, in which the feedback loop is opened at the node connecting resistor R_{f1} to output terminal 118, can be approximated as:

$$\frac{{v}_{out}}{{v}_{Rf 1}} \approx \frac{- {A}_{0} ( 1 - \frac{{C}_{gdp}}{{G}_{m 4}} s - \frac{{C}_{m} ( {C}_{gdp} + {C}_{gp} )}{{G}_{m 2} {r}_{o 2} {G}_{m 3} {G}_{m 4}} {s}^{2} )}{( 1 + \frac{s}{{w}_{3 d B}} ) ( \begin{matrix}1 + \frac{\begin{matrix}( {C}_{o} + {C}_{gdp} ) {R}_{Leff} + ( {C}_{gp} + {C}_{gdp} ) {r}_{o 3} + \\ {C}_{gdp} {r}_{o 3} {R}_{Leff} ( {G}_{m 4} - {G}_{m 3} {G}_{m 2} {r}_{o 2} )\end{matrix}}{{G}_{m 2} {r}_{o 2} {G}_{m 3} {r}_{o 3} {G}_{m 4} {R}_{Leff}} s + \\ \frac{{C}_{o} ( {C}_{gp} + {C}_{gdp} )}{{G}_{ m 2} {r}_{o 2} {G}_{m 3} {G}_{m 4}} {s}^{2}\end{matrix} )} \qquad ( 16 )$$

where the DC loop gain A₀ and the −3 dB dominant pole frequency ω_{3 dB} are given by:

A₀=βGₘ₁rₒ₁Gₘ₂rₒ₂Gₘ₃rₒ₃Gₘ₄R_{Leff} (17)

ω_{3 dB}=1/rₒ₁CₘGₘ₂rₒ₂Gₘ₃rₒ₃Gₘ₄R_{Leff} (18)

Gain Gₘ₂rₒ₂ offered by stage 2 of the error amplifier 113 appears in the denominator of the Equation (18). Thus, for a given value of compensation capacitor Cₘ, gain Gₘ₂rₒ₂ reduces the dominant pole frequency. Alternatively, for the same dominant pole frequency, the required value of the compensation capacitor Cₘ can be reduced by the factor of Gₘ₂rₒ₂, and thus reducing its chip area. While some prior art compensation techniques employ compensation capacitors ranging from 6 pF to 10 pF, an exemplary test chip implementing the LDO of FIG. 11 (various parameters of which are listed in Table 2) uses only 0.8 pF of compensation capacitance. In

As discussed in the background, for smaller load currents the non dominant poles of the prior art LDOs move closer to the dominant pole and reduce the phase margin. Additionally, magnitude peaking may occur due to complex non dominant poles at smaller loads. But the compensation technique used in LDO of FIGS. 10 and 11 pushes non dominant poles away from the dominant pole even at smaller loads, and additionally suppresses magnitude peaking due to complex non dominant poles. For example, the open loop transfer function of the LDO at light loads is expressed as:

$$\frac{{v}_{out}}{{v}_{Rf 1}} = \frac{- {A}_{0}}{( 1 + \frac{s}{{w}_{3 d B}} ) ( \begin{matrix}1 + \frac{\begin{matrix}{C}_{o} + {C}_{gdp} + \\ {C}_{gdp} {r}_{o 3} ( {G}_{m 4} - {G}_{m 3} {G}_{m 2} {r}_{o 2} )\end{matrix}}{{G}_{m 2} {r}_{o 2} {G}_{m 3} {r}_{o 3} {G}_{m 4}} s + \\ \frac{{C}_{o} ( {C}_{gp} + {C}_{gsp} )}{{G}_{m 2} {r}_{o 2} {G}_{m 3} {G}_{m 4}} {s}^{2}\end{matrix} )} \qquad ( 19 )$$

In addition to the dominant pole at ω_{3 dB}, there is a pair of complex conjugate poles. The frequency ωₒ at which the first non-dominant complex pole appears is given by the equation:

$${ω}_{o} = \sqrt{\frac{{G}_{m 2} {r}_{o 2} {G}_{m 3} {G}_{m 4}}{{C}_{o} ( {C}_{gp} + {C}_{gdp} )}} \qquad ( 20 )$$

where, the inclusion of the square root of the gain term Gₘ₂rₒ₂, which is the gain of stage 2 of the error amplifier 113, pushes the frequency ωₒ of non dominant complex poles to higher frequencies.

Magnitude peaking can be represented by the Q-factor of the complex conjugate poles, the equation of which is:

$$Q = \frac{{r}_{o 3} \sqrt{{G}_{m 2} {r}_{o 2} {G}_{m 3} {G}_{m 4} ( {C}_{gp} + {C}_{gdp} ) {C}_{o}}}{{C}_{0} + {C}_{gdp} + {C}_{gdp} + {r}_{o 3} ( {G}_{m 4} - {G}_{m 2} {r}_{o 2} {G}_{m 3} )} \qquad ( 21 )$$

Referring again to FIG. 11, as load current decreases, currents in M₁ 111 and M_{P} 110 also decrease. Consequently, the gate to source voltage |V_{GS1}| and |V_{GS2}| decrease causing |V_{GS3}| to increase and |V_{DS3}| to decrease. As a result, transistor M₃ 130 moves towards the triode region—reducing its output impedance. Because output impedance rₒ₃ is partially a function of the output impedance of transistor M₃ 130, rₒ₃ also decreases. In summary, at smaller load currents rₒ₃ decreases. As is evident from Equation (21), Q is directly proportional to rₒ₃. Therefore, at smaller loads Q also decreases. Having a low Q reduces magnitude peaking due to the non dominant complex poles. In other words, stage A_{S} 164 can be said to provide biasing that is adaptive to changes in load currents.

Furthermore, with decreasing load current both Gₘ₄ (which is equal to gₘₚ) and Gₘ₃ (which is equal to (gₘ₁+gₘ₃)) also decrease in magnitude. Therefore, the coefficient of s in the denominator of Equation (19) remains positive. This avoids the non dominant complex poles from appearing on the right half of s-plane, and thus, avoids instability.

FIG. 12 shows the simulated magnitude and phase plots for the open loop response of the LDO of FIG. 11 for various load currents ranging from 100 mA to 10 μA. Referring to the magnitude plots, the frequency ω_{GBW} at which the magnitude falls to unity is approximately equal to 10 MHz. Phase margin can be obtained by determining the phase value of each of the phase plots at ω_{GBW}, i.e., 10 MHz. The region marked 199 shows that the worst case phase margin occurs for a load current of 10 μA, and is equal to 60°. For all other values of load currents, the phase margin is approximately equal to 95°.

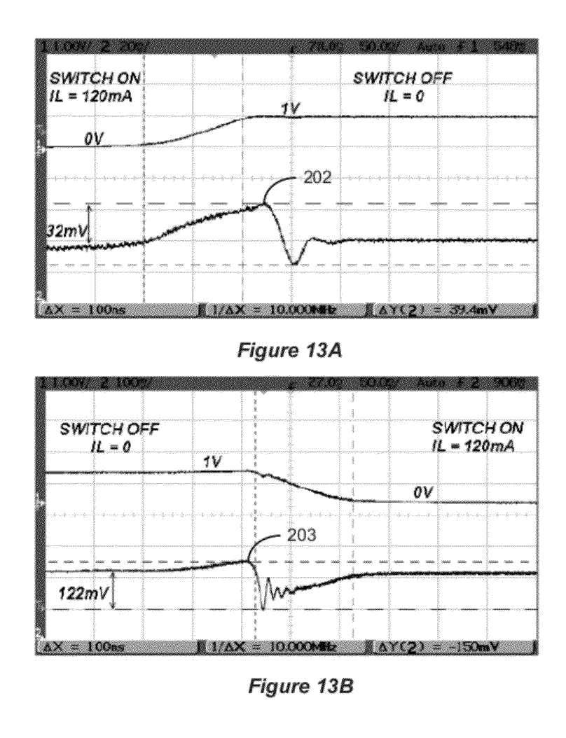

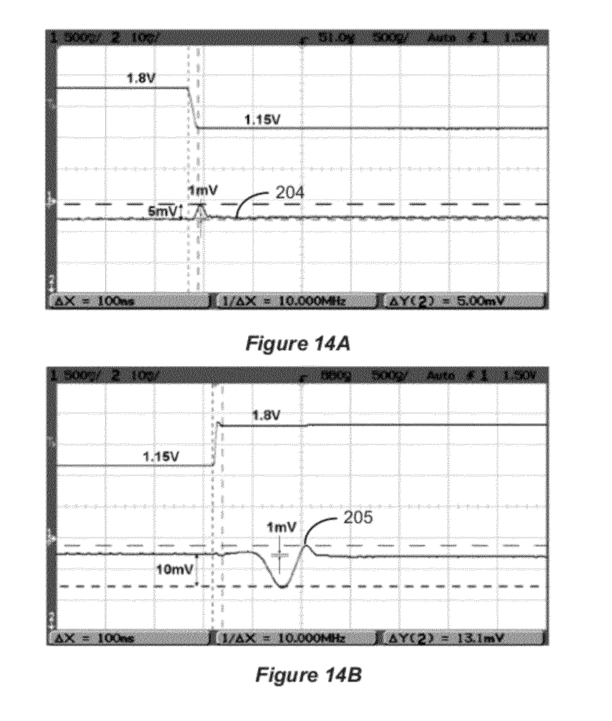

FIGS. 13A and 13B show the measured load transient response of the LDO of FIG. 11. Data shown in FIGS. 13 and 14 was obtained from testing a test chip implementing the LDO of FIG. 11. The LDO is designed to provide a Vₒᵤₜ of 1 V and a drop-out voltage of 0.15 V. FIG. 13A shows the load transient response 202 of the output voltage Vₒᵤₜ when the load current is switched from 120 mA to zero with a fall time of 100 ns. The output voltage Vₒᵤₜ settles within 0.25 μs with a maximum overshoot of 32 mV. FIG. 13B shows the transient response 203 of the output voltage Vₒᵤₜ with the load current is switched from zero to 120 mA with a rise time of 100 ns. The output voltage settles within 0.25 μs with a maximum undershoot of 122 mV. Overall, the measured load regulation is 58.3 μV/mA.

FIG. 14A shows the measured line transient response 204 of the output voltage Vₒᵤₜ when the input voltage is changed from 1.8 V to 1.15 V with a fall time of 100 ns at a load current of 120 mA. The maximum overshoot is measured to be 5 mV. FIG. 14B shows the line transient response 205 when the input voltage is switched from 1.15 V to 1.8 V with a rise time of 100 ns at a load current of 120 mA. The maximum undershoot is measured to be 10 mV. Overall, the measured line regulation is 1.54 μV/mV, and the response time is 15 ps.

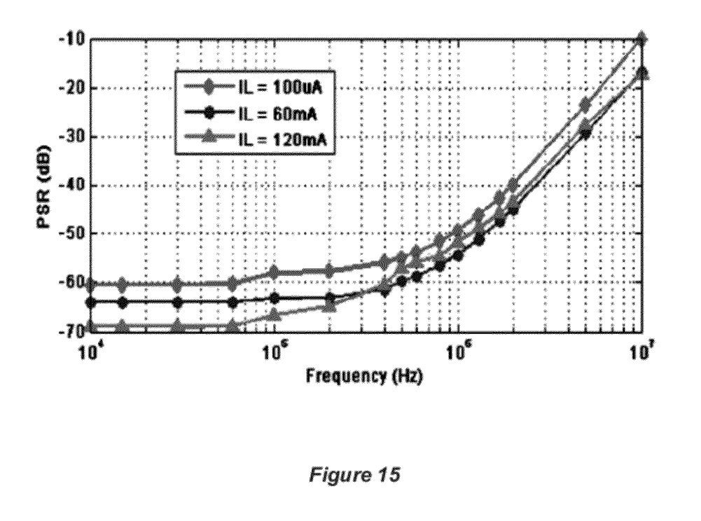

FIG. 15 shows the measured PSR of the test chip implementing the LDO of FIG. 11 as a function of load current varied from 100 μA to 100 mA. The PSR is at least −60 dB at lower frequencies and in the range of −55 to −50 dB at 1 MHz. At 10 MHz, the PSR is in the range of −17 to −10 dB. Thus, while the prior art LDOs provide adequate PSR only up to tens or hundreds of kilohertz, the LDO of FIG. 11 provides high PSR well above 10 MHz.

Table 2 lists various metrics of the LDO tested in FIGS. 13-15:

TABLE 2

| Parameter | value | |
|---|---|---|
| Technology | 0.09 | μm |
| Active Area | 0.016 | mm² |
| Input Voltage (Vᵢₙ) | 1.15 | V |
| Output Voltage (Vₒᵤₜ) | 1 | V |
| Dropout voltage | 0.15 | V |
| Maximum load current | 120 | mA |
| Quiescent load current | 28-122 | mA |
| Current Efficiency | 99.9% | |
| PSR @ 10 kHz | −60 | dB |
| PSR @ 1 MHz | −50 | dB |
| Response time | 0.015 | ns |
| Settling time | 0.25 | μs |
| Load Regulation | 0.058 | mV/mA |
| Cₘ | 0.8 | pF |
| R_{c} | 40 | kΩ |
| C_{c} | 0.15 | pF |

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A low dropout voltage regulator, comprising:
an input terminal having an input voltage;
an output terminal having an output voltage;
a pass transistor, wherein the pass transistor receives the input voltage at its source, and produces the output voltage at its drain; and
a feedback loop for receiving the input voltage and the output voltage, and for producing at a gate of the pass transistor a gate signal, wherein the gate signal is a function of both a transconductance of the pass transistor and an output resistance of the pass transistor.

2. The low dropout voltage regulator of claim 1, wherein the gate signal comprises a sum of the input voltage and a product of the input voltage and a reciprocal of a gain provided by the pass transistor.

3. The low dropout voltage regulator of claim 1, the feedback loop comprising an amplifier stage providing a gain A_{S}, wherein the pass transistor provides a gain A_{MP}, and wherein A_{MP} times A_{S} is approximately 1.

4. The low dropout voltage regulator of claim 1, wherein the pass transistor is a MOS transistor.

5. The low dropout voltage regulator of claim 4, wherein the pass transistor is a p-channel transistor.

6. A low dropout voltage regulator, comprising:
an input terminal having an input voltage;
an output terminal having an output voltage;
a pass transistor, wherein the pass transistor receives the input voltage at its source, and produces the output voltage at its drain;
an error amplifier for providing an error amplifier output and for receiving an indication of the output voltage; and
an amplifier stage for receiving the error amplifier output and the input voltage and for producing at a gate of the pass transistor a signal, wherein the signal is a function of both a transconductance of the pass transistor and an output resistance of the pass transistor.

7. The low dropout voltage regulator of claim 6, wherein the pass transistor provides a gain A_{MP}, wherein the amplifier stage provides a gain A_{S}, and wherein A_{MP} times A_{S} is approximately 1.

8. The low dropout voltage regulator of claim 6, wherein the pass transistor is a MOS transistor.

9. The low dropout voltage regulator of claim 8, wherein the pass transistor is a p-channel transistor.

10. The low dropout voltage regulator of claim 6, further comprising a voltage divider, wherein the voltage divider receives the output voltage and produces the indication of the output voltage within the voltage divider.

11. The low dropout voltage regulator of claim 10, wherein the voltage divider is formed of resistors.

12. The low dropout voltage regulator of claim 6, wherein the error amplifier receives the indication of the output voltage at a first input and a reference voltage at a second input.

13. The low dropout voltage regulator of claim 6, wherein the low dropout voltage regulator is implemented in an integrated circuit, and further comprising a circuit block for receiving the output voltage as a power supply, and wherein the circuit block is also integrated on the integrated circuit.

14. A low dropout voltage regulator, comprising:
an input terminal having an input voltage;
an output terminal having an output voltage;
an error amplifier for providing at an error amplifier output and for receiving an indication of the output voltage;
a first transistor for receiving the error amplifier output at its gate and ground at its source;
a second transistor coupled to a drain of the first transistor at its drain and gate, wherein the second transistor receives the input voltage at its source;
a third transistor for receiving the error amplifier output at its gate, wherein the third transistor receives the input voltage at its source and receives the drain of the first transistor at its drain; and
a pass transistor, wherein the pass transistor receiving the input voltage at its source, produces the output voltage at its drain, and receives the gate of the second transistor at its gate.

15. The low dropout voltage regulator of claim 14, wherein the transistors are MOS transistors.

16. The low dropout voltage regulator of claim 14, further comprising a voltage divider, wherein the voltage divider receives the output voltage and produces the indication of the output voltage within the voltage divider.

17. The low dropout voltage regulator of claim 16, wherein the voltage divider is formed of resistors.

18. The low dropout voltage regulator of claim 14, wherein the pass transistor, the second transistor, and the third transistor each comprise p-channel transistors, and wherein the first transistor comprises an n-channel transistor.

19. The low dropout voltage regulator of claim 14, wherein the error amplifier receives the indication of the output voltage at a first input and a reference voltage at a second input.

20. The low dropout voltage regulator of claim 14, wherein the low dropout voltage regulator is implemented in an integrated circuit, and further comprising a circuit block for receiving the output voltage as a power supply, and wherein the circuit block is also integrated on the integrated circuit.

21. The low dropout voltage regulator of claim 14, further comprising a load capacitor connected to the output terminal.

22. The low dropout voltage regulator of claim 14, further comprising:
a compensation capacitor connected between the error amplifier output and an internal node of the error amplifier,
wherein the error amplifier includes a plurality of gain stages, and
wherein the internal node connects an output of one of the plurality of gain stages to an input of another one of the plurality of gain stages.

23. The low dropout voltage regulator of claim 22, further comprising an RC network connected between the internal node of the error amplifier and the error amplifier output.

24. A low dropout voltage regulator, comprising:
a pass transistor;
a feedback loop comprising an error amplifier, wherein the feedback loop is coupled between an output of the voltage regulator and a gate terminal of the pass transistor, the error amplifier having a plurality of gain stages and an output; and
a compensation capacitor coupled between the output of the voltage regulator and an internal node of the error amplifier,
wherein the internal node connects an output of one of the plurality of gain stages to an input of another one of the plurality of gain stages.

25. The low dropout voltage regulator of claim 24, further comprising an RC network connected between the internal node of the error amplifier and the output of the error amplifier.

26. The low dropout voltage regulator of claim 25, wherein the RC network creates a zero in a transfer function of the voltage regulator, wherein the zero cancels a pole in the transfer function corresponding to the output of the error amplifier.

27. The low dropout voltage regulator of claim 24, the feedback loop further comprising: an amplifier stage coupled between the output of the error amplifier and the gate terminal of the pass transistor, wherein the pass transistor provides a gain A_{MP}, wherein the amplifier stage provides a gain A_{S}, and wherein A_{MP} times A_{S} is approximately 1.

28. The low dropout voltage regulator of claim 24, wherein the low dropout voltage regulator is implemented in an integrated circuit, and further comprising a circuit block for receiving the output of the voltage regulator as a power supply input, and wherein the circuit block is also integrated on the integrated circuit.

29. The low dropout voltage regulator of claim 24, wherein the value of the compensation capacitor is no more than 0.8 pF.

30. The low dropout voltage regulator of claim 24, wherein the pass transistor is a MOS transistor.

31. The low dropout voltage regulator of claim 30, wherein the pass transistor is a p-channel MOS transistor.

32. The low dropout voltage regulator of claim 24, wherein the error amplifier receives an indication of an output voltage of the voltage regulator at a first input and a reference voltage at a second input.

33. The low dropout voltage of claim 32, the feedback loop further comprising a voltage divider, wherein the voltage divider receives the output voltage of the voltage regulator and produces the indication of the output voltage of the voltage regulator within the voltage divider.

34. The low dropout voltage regulator of claim 33, wherein the voltage divider is formed of resistors.
